(19) United States
(12) Patent Application Publication
(10) Pub. No.: US 2003/0117035 A1
(43) Pub. Date: Jun. 26, 2003

(54) Brush holder for commutating machines

(76) Inventor: Jens Gerstenberger, Hannover (DE)

Correspondence Address: Striker Striker & Stenby, 103 East Neck Road, Huntington, NY, 11743, US

(21) Appl. No.: 10/111,881

(22) PCT Filed: Jul. 6, 2001
(86) PCT No.: PCT/DE01/02514

(51) Int. Cl. H02K 13/00

(52) U.S. Cl. 310/239

(57) ABSTRACT

A brush holder for commutator machines is disclosed, which has a plurality of commutator brushes (15), embodied for nonpositive assembly on a commutator (18) of the commutator machine, each of which brushes is guided axially displaceably with play in a brush quiver (12) and is urged in the expulsion direction from the brush quiver (12) by a brush compression spring (16) that is braced between the brush quiver (12) and the commutator brush (15). In each brush quiver (12), a restraining member (21) is provided as an assembly aid, which restrains the spring-loaded commutator brush (16) in the assembly by positive engagement on the brush quiver (12) and releases it after the assembly. To achieve an assembly aid that is very simple to produce and saves assembly time, the restraining member (20) is an integral part of the brush quiver (12) and is embodied such that the positive engagement can be generated by slightly tilting the commutator brush (15) in the brush quiver (12) and can be undone again by straightening it (FIG. 4).

### PRIOR ART

The invention is based on a brush holder for commutator machines as generically defined by the preamble to claim 1.

In the production and assembly of known brush holders, an assembly-aiding ring is used, which in the completed brush holder restrains the spring-loaded commutator brushes in the brush quivers. This assembly ring is removed upon joining of the brush holder to the commutator or collector in the commutator machine and transported back to the assembly station.

To dispense with the assembly aid ring and thus along with the omission of transporting the assembly ring back again to achieve production advantages, in a known brush holder of the type defined at the outset (European Patent Disclosure EP 0 741 438 B1), a lead line connector for the commutator brush has a retaining portion, which when the commutator brush and the brush compression spring have been inserted in the brush quiver, fits over the face end, remote from the brush compression spring, of the commutator brush and thus prevents the spring-prestressed commutator brush from escaping from the brush quiver. Once the brush holder has been joined in the commutator machine, this retaining portion in each of the brush quivers retained on the brush pressure plate is bent outward, thus releasing one commutator brush each, and all of the commutator brushes are pressed by the brush compression springs onto the commutator laminations of the commutator.

### ADVANTAGES OF THE INVENTION

The brush holder of the invention has the advantage that by using the lateral guidance play of the commutator brush in the brush quiver, the restraining member is realized by means of a simple machining provision on the brush quiver itself, and thus a positive engagement can be established between the commutator brush and the brush quiver. This positive engagement, which is achieved without placing an additional component in the brush quiver, reliably keeps the prestressed commutator brush in the brush quiver during the entire assembly process. On doing the positive engagement after the incorporation of the brush holder into the commutator machine can then be accomplished easily in various ways.

By means of the provisions recited in the other claims, advantageous refinements of and improvements to the brush holder defined by claim 1 are possible.

In a preferred exemplary embodiment of the invention, the restraining member can be achieved structurally in a very simple way on the one hand by dimensioning the guidance play between the brush quiver and the commutator brush such that the commutator brush is capable of assuming an oblique position in the brush quiver, in which position the brush axis and the quiver axis form a small acute angle, and on the other hand embodying a detent shoulder, on one of the quiver walls of the brush quiver, that cooperates with the commutator brush in its oblique position.

In an advantageous embodiment of the invention, the detent shoulder, near the brush exit edge of the brush quiver, extends over the entire width of the quiver wall, and the obliquely positioned commutator brush is braced with its face end, remote from the brush compression spring, on the detent shoulder.

In alternative embodiments of the invention, the detent shoulder is formed by the lower edge of a recess that fully penetrates the quiver wall or by the lower flank of a groovelike indentation made on the inside of the quiver wall. Making and breaking, or undoing, the positive engagement between the commutator brush and the brush quiver are done by exerting force on the free face end of the commutator brush and on the side face of the commutator brush, respectively; to attain an oblique position, the insertion force for inserting the commutator brush into the brush quiver counter to the force of the brush compression spring engages the free face end of the commutator brush eccentrically, specifically in a way offset toward the quiver wall that has the detent shoulder. The exertion of force on the side face of the commutator brushes is done from outside, through the quiver wall, for the sake of which suitable through bores or slits open into the indentation defined by the detent shoulder.

In a preferred embodiment of the invention, the detent shoulder is disposed in the quiver wall in such a way that when the face end of the commutator brush is resting on the detent shoulder, part of the face end protrudes past the brush exit edge of the brush quiver, far enough that when the brush holder is joined to the commutator, the latter abuts against the face end of the commutator brush. If the commutator is then advanced farther, the brush is pressed inward slightly by the commutator and pivoted backward by the commutator laminations in such a way that its brush axis is oriented virtually parallel to the quiver axis, and as a result the face end of the commutator brushes is pulled away from the detent shoulder. By this means, the undoing of the positive engagement between the commutator brushes and the individual brush quivers advantageously takes place automatically by the insertion of the commutator, and additional assembly processes or auxiliary tools for exerting a shear force on the commutator brush can be dispensed with.

### DRAWING

The invention is explained in further detail in the ensuing description in terms of an exemplary embodiment shown in the drawing. The drawings schematically show the following:

FIG. 1, a perspective view of a detail of a commutator of a commutator machine with a built-in brush holder;

FIG. 2, a section taken along the line II-II in FIG. 1;

FIGS. 3 and 4, respective longitudinal sections through a brush quiver of the brush holder in FIGS. 1 and 2 with a commutator brush and a brush compression spring, in two successive phases of the assembly process;

FIGS. 5-7, respective longitudinal sections through a modified brush quiver in accordance with three further exemplary embodiments.

### DESCRIPTION OF THE EXEMPLARY EMBODIMENTS

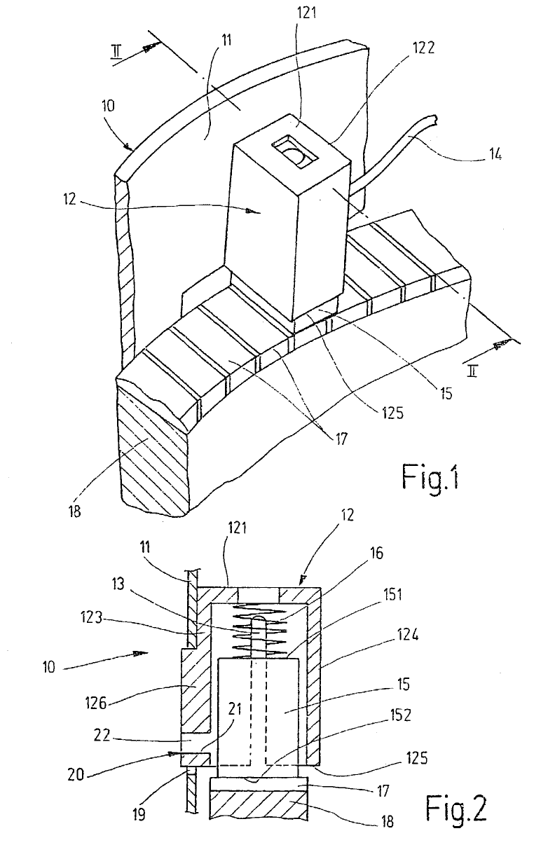

The brush holder 10, shown in fragmentary perspective view in FIG. 1 and in section in FIG. 2, for a commutator machine shown in fragmentary form, for instance for a direct current motor, has a brush plate 11, to which at least two radially oriented brush quivers 12, offset from one another by equal circumferential angles, are secured. Each brush quiver 12 is shaped in boxlike fashion with a rectangular cross section and is closed on one face end by a quiver bottom 121. A detent cam 126 is formed onto one of the lateral quiver walls 123, and with it the brush quiver 12 is inserted into a detent recess 19 in the brush plate 11 and locked into place there. Another lateral quiver wall 122 is provided with a longitudinal slit 13 (FIG. 2), made eccentrically from the edge of the quiver, for the passage through it of a stranded brush connection cable 14 (FIG. 1). A commutator brush 15 is inserted into the brush quiver 12 and is guided axially displaceably with relatively great play in the brush quiver 12. A brush compression spring 16, braced between the quiver bottom 121 and the face end 151 oriented toward it of the commutator brush 15, presses the commutator brush 15, after the brush holder 10 has been installed, against the commutator laminations 17 of a commutator 18 of the commutator machine. Although not shown further, the brush holder 10 in the commutator machine is fixed nonrotatably via the brush plate 11.

In the manufacture of the commutator machine, the brush holder 10 is preassembled as a complete unit and inserted into the commutator machine; in automated production, the preassembly station for the brush holder is often remote from the final assembly station of the commutator machine, and the completed brush holder 10 with prestressed brush compression springs 16 must still traverse relatively long transport distances.

In order during the assembly to hold the spring-loaded commutator brushes 15 securely in the brush quivers 12, a restraining member 20 is integrated with each brush quiver 12; the restraining member prevents an expulsion of the spring-loaded commutator brush 15 from the brush quiver 12. This restraining member 20 is activated in the assembly of the brush holder 10 and is kept activated until the brush holder 10 is installed in the commutator machine, and at the end of assembly, or in other words once the brush holder 10 has been fixed in the commutator machine and the commutator 18 has been installed, it is deactivated again.

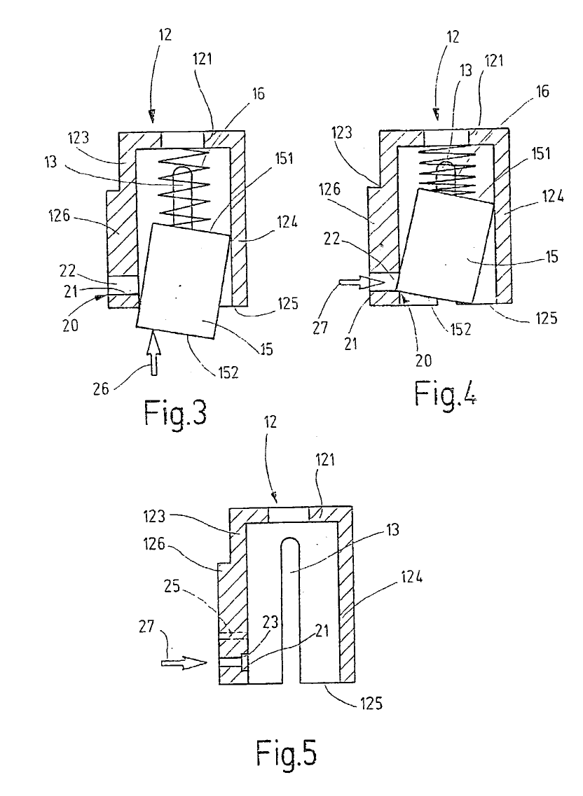

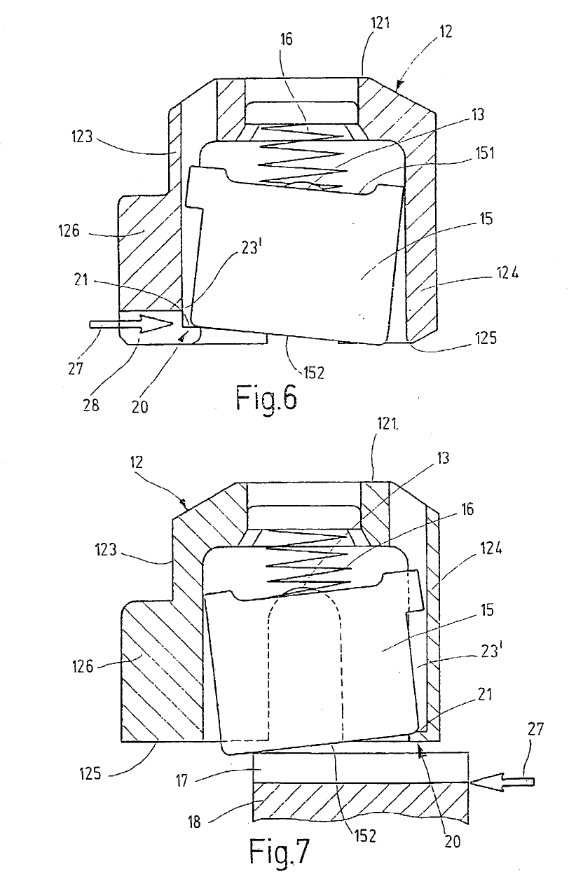

To achieve a structurally simple restraining member 20 that saves assembly time, on the one hand the existing play between the brush quiver 12 and the commutator brush 15 is utilized, which play suffices to allow the commutator brush 15 to assume an oblique position, in which the brush axis forms a small acute angle with the quiver axis (see FIGS. 3 and 4); on the other hand, in a quiver wall 123 near the brush exit edge 125 of the brush quiver 12, a detent shoulder 21 is provided, which by slightly tilting the commutator brush 15 with the commutator brush 15 in its oblique position establishes a positive engagement. The detent shoulder 21 extends over the entire width of the quiver wall 123, so that the obliquely positioned commutator brush 15 can rest, with its face end 152 remote from the brush compression spring 16, on the detent shoulder 21. In the exemplary embodiment of FIGS. 1-4, the detent shoulder 21 is formed by the lower edge, toward the brush exit edge 125, of a recess 22 that penetrates all the way through the quiver wall 123, while in the exemplary embodiment of FIGS. 5 and 6 it is formed by the lower groove flank, toward the brush exit edge 125, of a groovelike indentation 23 or 23′ extending along the inside of the quiver wall 123. In this latter case, a through bore 24 (FIG. 5) or a slit 28 (FIG. 6) is also made in the quiver wall 122, and this opening or slit opens into the indentation 23 or 23′. Instead of the through bore 24, a through bore 25 extending near the indentation 23 can also be provided, which is represented by dashed lines in FIG. 5. For producing the brush quiver 12 as a plastic injection-molded part, the indentation 23′ is extended as far as the quiver bottom 121 and punches through it (FIGS. 6 and 7), to enable unmolding the brush quiver 12 from the injection-molding tool.

Two steps in the assembly process of the brush holder 10 are shown schematically in FIGS. 3 and 4. After the brush compression spring 16 has been placed in the brush quiver 12, the commutator brush 15 is inserted, tensing the brush compression spring 16, into the brush quiver 12. For activating the restraining member 20, the insertion force, which is symbolically represented in FIG. 3 by arrow 26, engages the free face end 152 of the commutator brush 15 eccentrically, specifically being offset toward the quiver wall 123 that has the detent shoulder 21. As a result, the commutator brush 15 assumes an oblique position inside the brush quiver 12, which position is illustrated in FIGS. 3 and 4, and at the end of the insertion operation, the commutator brush 15 comes to rest with its face end 152 against the detent shoulder 21. This contact is further reinforced by the brush compression spring 16, since because of the oblique position a force component of the pressure force of the brush compression spring 16 displaces the commutator brush 15 laterally. Between the restraining member 20 in brush quiver 12 and the commutator brush 15, a positive engagement is established, and in this assembly state of the brush quiver 12 equipped with the commutator brushes 15 and the brush compression springs 16, the brush holder 10 can be further completed and finally inserted into the commutator machine and fixed there.

Once the assembly is complete, the last step is that the positive engagement between the restraining member 20 and the commutator brush 15 in each brush quiver 12 is undone, by providing that—as represented in FIGS. 4-6 by arrow 27—the commutator brush 15 is urged by a shear force 27 through the recess 22 (FIG. 4), or through the bore 24 or 25 (FIG. 5), or through the slit 28 (FIG. 6), and by means of this shear force 27 is thrust in the direction of the opposite quiver wall 124. As a result, the commutator brush 15 is pushed with its face end 152 off from the detent shoulder 21, and the brush compression spring 16 presses the commutator brush 15 with its face end 152 against the commutator laminations 17 of the commutator 18.

The exemplary embodiment, shown in FIG. 7, of a brush quiver 12 shown in longitudinal section with a commutator brush 15 is modified to the extent that the detent cam 126 is disposed on the quiver wall 123 and the restraining member 20 is disposed on the quiver wall 124, or in other words in transposed positions compared to the exemplary embodiments of the brush quiver in FIGS. 1-5. Once again, the restraining member 20 is embodied as a detent shoulder 21, which is disposed on the quiver wall 124 at the brush exit edge 125 of the brush quiver 12 and is formed by the lower groove flank, toward the brush exit edge 125, of the groovelike indentation 23′. By inserting the commutator brush 15 into the brush quiver 12 with an eccentrically engaging insertion force acting counter to the brush compression spring 16, the commutator brush 15 is again fixed with its free face end 152 on the detent shoulder 21. The disposition and embodiment of the detent shoulder 21 are selected such that part of the side face of the face end 152 of the commutator brush 15 protrudes past the brush exit edge 125 of the brush quiver 12, far enough that it protrudes into the insertion range of the commutator 18. If now, once the brush holder 10 has been secured in the commutator machine, the commutator 18 is inserted in the direction of arrow 27 in FIG. 7, then the commutator 18 with its front edge strikes the face end 152 of the commutator brush 15 and pushes it into the brush quiver 12, as a result of which the commutator brush 15 straightens, and its face end 152 slides away from the detent shoulder 21. By means of the brush compression spring 16, the commutator brush 15 is now pressed onto the commutator lamination 17 of the commutator 18.

1. A brush holder for commutator machines, having a plurality of commutator brushes (15), embodied for non-positive assembly on a commutator (18) of the commutator machine, of which commutator brushes each one is guided axially displaceably with play in a brush quiver (12) and is urged by a brush compression spring (16), braced between the brush quiver (12) and the commutator brush (15), in the expulsion direction from the brush quiver (12), and having a restraining member (20), contained as an assembly aid in the brush quiver (12), which restraining member, by means of positive engagement that can be undone after the assembly, with the commutator brush blocks the spring-loaded commutator brush (15) against expulsion from the brush quiver (12), characterized in that the restraining member (20) is an integral part of the brush quiver (12) and is embodied such that the positive engagement can be generated by slightly tilting the commutator brush (15) in the brush quiver (12) counter to the quiver axis and can be undone again by straightening the commutator brush (15).

2. The brush holder of claim 1, characterized in that the guidance play between the brush quiver (12) and the commutator brush (15) is dimensioned such that the commutator brush (15) in the brush quiver (12) is capable of assuming an oblique position, in which the brush axis forms a small acute angle with the quiver axis, and that the restraining member (20) is formed by a detent shoulder (21), cooperating with the commutator brush (15) in the oblique position thereof, which detent shoulder is machined into one of the quiver walls (123) of the brush quiver (12).

3. The brush holder of claim 2, characterized in that the detent shoulder (21) extends near the brush exit edge (125) of the brush quiver (12) over the entire width of the quiver wall (123), and that the obliquely placed commutator brush (15) rests, with its face end (152) remote from the brush compression spring (16), on the detent shoulder (21).

4. The brush holder of claim 2 or 3, characterized in that the detent shoulder (21) is formed by the lower edge, oriented toward the brush exit edge (125), of a recess (22) that completely penetrates the quiver wall (123).

5. The brush holder of claim 2 or 3, characterized in that the detent shoulder (21) is formed by the lower edge, oriented toward the brush exit edge (125), of a groovelike indentation (23) made in the inside of the quiver wall (123).

6. The brush holder of one of claims 3-5, characterized in that to undo the positive engagement between the detent shoulder (21) and the commutator brush (15), a shear force extending transversely to the quiver axis can be brought to bear on the commutator brush (15).

7. The brush holder of claims 5 and 6, characterized in that in the quiver wall (123) that has the indentation (23, 23′), a through bore (24, 25) or a slit (28) open as far as the brush exit edge (125) is made, which bore or slit discharges into the indentation (23, 23′).

8. The brush holder of claims 3 and 6, characterized in that the detent shoulder (21) is disposed such that when the face end (152) of the commutator brush (15) is resting on the detent shoulder (21), part of the face end (152) protrudes past the brush exit edge (125) of the brush quiver (12) so far that in the joining of the brush holder (10) to the commutator (128), the latter abuts against the face end (152) of the commutator brush.

9. The brush holder of claim 8, characterized in that the detent shoulder (21) is embodied on the quiver wall (124), located at the front in the joining direction of the commutator (18), of the brush quiver (12).

10. The brush holder of one of claims 2-9, characterized in that the tilting of the commutator brush (15) can be accomplished by means of an insertion force (26), which for insertion of the commutator brush (15) into the brush quiver (12) counter to the force of the brush compression spring (16) engages the face end (152) of the commutator brush (15) eccentrically, offset toward the quiver wall (123) that has the detent shoulder (21).
